(19) United States
(12) Patent Application Publication
(10) Pub. No.: US 2013/0322056 A1
(43) Pub. Date: Dec. 5, 2013

(54) LIGHT SOURCE DEVICE AND IMAGE DISPLAY APPARATUS

(71) Applicant: Hitachi Media Eletronics Co., Ltd., Oshu-shi (JP)

(72) Inventors: Nobuhiro KONUMA, Yokohama (JP); Jun HATO, Fujisawa (JP); Akio YABE, Fujisawa (JP)

(73) Assignee: Hitachi Media Eletronics Co., Ltd., Oshu-shi (JP)

(21) Appl. No.: 13/904,472

(22) Filed: May 29, 2013

(30) Foreign Application Priority Data
May 30, 2012 (JP) 2012-122642

(51) Int. Cl. F21V 13/14

(52) U.S. Cl. CPC F21V 13/14
USPC 362/84

(57) ABSTRACT

A light source device and an image display apparatus include a Blue Laser Diode (B-LD) light source unit, a dichroic mirror to reflect substantially collimated Blue (B) light from the B-LD light source unit, a lens to focus the B light reflected by the dichroic mirror, and a color wheel comprising a Green (G) fluorescent section which is excited by the collimated B light to emit and to reflect G light and a B mirror reflector to mirror-reflect the B light, wherein a center of a light flux of the B light reflected by the dichroic mirror is on other than an optical axis of the lens.

### INCORPORATION BY REFERENCE

The present application claims priority from Japanese application JP2012-122642 filed on May 30, 2012, the content of which is hereby incorporated by reference into this application.

### BACKGROUND OF THE INVENTION

The present invention relates to a light source device and an image display apparatus and is suitably applicable to a light source device and an image display apparatus including, for example, a blue laser light source and a color wheel including a fluorescent substance.

There have been proposed a light source device and an image display apparatus including, in place of an ultra-high pressure mercury lamp, a blue laser light source and a color wheel including a green fluorescent substance, to thereby emit blue light and green light. As compared with the ultra-high pressure mercury lamp, it is possible to instantaneously turn the blue laser light source on and off. Hence, it is advantageously possible that the image display apparatus is installed and uninstalled in a short period of time. Also, the blue laser light source has longer life than the ultra-high pressure mercury lamp and is hence advantageously less frequently replaced.

JP4711021B2 (corresponding to U.S. Pat. No. 8,403,492B2, Shibasaki) describes a configuration including a green fluorescence reflection unit to emit light by use of blue laser light as its excitation light and a diffusion transmission unit which diffuses and transmits the blue laser light.

As excitation light for the fluorescent substance, blue laser light is employed in place of ultraviolet light. As a result, the blue fluorescent substance is not required for the color wheel. In general, blue light is higher in the transmittivity than the ultraviolet light in optical glass and optical resin used for lenses and mirrors and hence improves the light utilization efficiency. Also, the lenses and mirrors are improved in durability against light.

### SUMMARY OF THE INVENTION

However, in the light source device and the image display apparatus described in JP4711021B2, the color wheel reflects green light and transmits blue light. To combine blue light transmitted through the color wheel with green light reflected by the color wheel, it is required to additionally employ a blue light detour path after the color wheel, the blue light detour path including a plurality of lenses (50 to 52 of FIG. 2 in JP4711021B2) and a plurality of mirrors (26 and 27 of FIG. 2 in JP4711021B2). The requirement of the blue light detour path leads to a problem that the optical system of the light source device is enlarged in size and the number of optical parts becomes larger.

By using a color wheel including a blue fluorescent substance reflection unit which uses ultraviolet light in place of blue light as excitation light to emit light, it is possible to reflect also the blue light by the color wheel. However, as described above, when ultraviolet light is employed as excitation light, it is required that the color wheel includes a blue fluorescent substance. Since the transmittivity is low in optical glass and optical resin employed for lenses and mirrors, the light utilization efficiency is reduced. This results in a problem that for the lenses and mirrors, durability against light is lowered.

It is therefore an object of the present invention, which is devised in consideration of the problems above, to provide a light source device and an image display apparatus in which ultraviolet light is not used as excitation light and both of green light and blue light are reflected by a color wheel to remove the blue-light detour path, to thereby realize downsizing and to reduce the number of parts of the light source device and the image display apparatus.

To achieve the object according to the present invention, there is provided a light source device and an image display apparatus including a Blue Laser Diode (B-LD) light source unit, a dichroic mirror to reflect substantially collimated Blue (B) light from the B-LD light source unit, a lens to focus the B light reflected by the dichroic mirror, and a color wheel comprising a Green (G) fluorescent section which is excited by the collimated B light to emit and to reflect G light and a B mirror reflector to mirror-reflect the B light, wherein a center of a light flux of the B light reflected by the dichroic mirror is on other than an optical axis of the lens.

Further, the B light reflected by the dichroic mirror passes through substantially a half-section with respect to the optical axis of the lens.

Also, to achieve the object according to the present invention, there is provided a light source device and an image display apparatus including a Blue Laser Diode (B-LD) light source unit, a dichroic mirror to transmit substantially collimated Blue (B) light from the B-LD light source unit, a lens to focus the B light transmitted by the dichroic mirror, and a color wheel comprising a Green (G) fluorescent section which is excited by the collimated B light to emit and to reflect G light and a B mirror reflector to mirror-reflect the B light, wherein a center of a light flux of the B light transmitted by the dichroic mirror is on other than an optical axis of the lens.

Further, the B light transmitted by the dichroic mirror passes through substantially a half-section with respect to the optical axis of the lens.

According to the present invention, a configuration in which the color wheel reflects both of green light and blue light is implemented. Hence, there are advantageously provided a light source device and an image display apparatus in which by removing the blue-light detour path, the size and the number of parts thereof are reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a top view showing main sections of a light source device and an image display apparatus in a first embodiment according to the present invention;

FIG. 2 is a plan view of a color wheel of the first embodiment;

FIG. 3 is a top view showing main sections of a light source device and an image display apparatus in a second embodiment according to the present invention;

FIG. 4 is a top view showing main sections of a light source device and an image display apparatus in a third embodiment according to the present invention;

FIG. 5 is a top view of a color wheel of the third embodiment;

FIG. 6 is a top view showing main sections of a light source device and an image display apparatus in a fourth embodiment according to the present invention; and

FIG. 7 is a top view showing main sections of a light source device and an image display apparatus in a fifth embodiment according to the present invention.

### DESCRIPTION OF THE EMBODIMENTS

Next, description will be given of embodiments of the present invention by referring to the accompanying drawings.

### First Embodiment

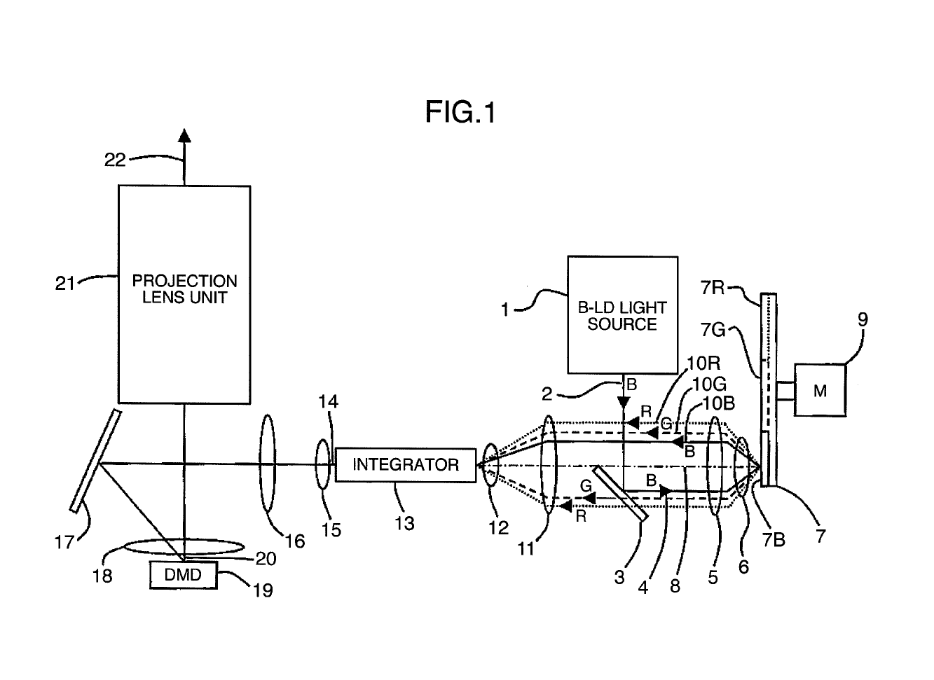

FIG. 1 shows, in a top view, main sections of a light source device and an image display apparatus in a first embodiment according to the present invention.

Substantially collimated blue (B) light 2 from a blue laser diode (B-LD) light source 1 enters a dichroic mirror 3. Hereinbelow, the blue laser diode is abbreviated as B-LD and blue is abbreviated as B. The B-LD light source 1 includes a plurality of B-LD, not shown. The dichroic mirror 3 has a spectral transmissive reflectivity characteristic to reflect B light and to transmit green (G) light and red (R) light. Hereinbelow, green is abbreviated as G and red is abbreviated as R.

B light 4 reflected by the dichroic mirror 3 is refracted through a lens 5 and a lens 6 to be focused substantially onto one point and then enters a color wheel 7.

In this configuration, the lenses 5 and 6 have a shared optical axis 8, and the B light 4 transmits substantially the lower-half section below the optical axis 8 in FIG. 1. That is, the dichroic mirror 3 is disposed in substantially the lower-half section below the optical axis 8.

In the configuration of the first embodiment, the B light 4 transmits through substantially the lower-half section below the optical axis in FIG. 1. However, the present invention is not restricted by this embodiment. The gist of the present invention resides in that the center of the light flux of the B light 4 reflected by the dichroic mirror 3 is on other than the optical axis 8 of the lenses 5 and 6. Various modifications and variations are possible within the scope of the present invention.

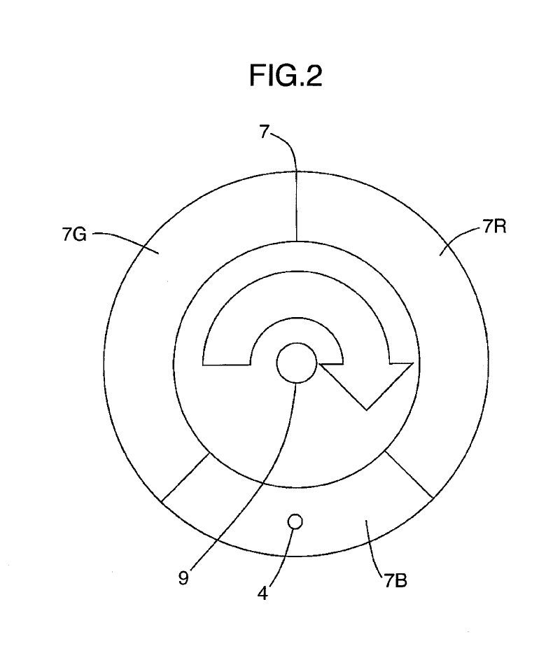

FIG. 2 is a plan view of the color wheel 7 of the first embodiment.

The color wheel 7 circumferentially includes a B light mirror reflection unit or mirror reflector 7B, a G fluorescent reflector 7G and an R fluorescent reflector 7R. By rotating the color wheel 7 by a motor 9, the reflector to receive the B light 4 is changed in a time-division manner. FIG. 2 shows a state in which the B light 4 is just incident onto the B light mirror reflector 7B.

FIG. 1 also shows a state in which the B light 4 just enters the B light mirror reflector 7B. The B light 4 is mirror-reflected by the B light mirror reflector 7B. Reflected B light 10B propagates through substantially the lower-half section above the optical axis 8 in FIG. 1 and is refracted through the lenses 6 and 6 to be again substantially collimated. The light passes other than the section of the color wheel 7 in which the dichroic mirror 3 is disposed, and then enters an integrator 13 via a lens 11 and a lens 12.

Next, description will be given of a situation in which the B light 4 enters the G fluorescent reflector 7G of the color wheel 7. For the B light 4, G light excited by the G fluorescent reflector 7G is diffused and reflected. Of reflected G light 10G, light in substantially the lower-half section below the optical axis 8 in FIG. 1 is refracted through the lenses 6 and 5 to be substantially collimated. The light transmits through the dichroic mirror 3 and enters the integrator 13 via the lenses 11 and 12. Of the reflected G light 10G, light in substantially the upper-half section above the optical axis 8 in FIG. 1 is refracted by the lenses 6 and 5 to be substantially collimated. The light passes other than the section of the color wheel 7 in which the dichroic mirror 3 is disposed, and enters the integrator 13 via the lenses 11 and 12.

Description will now be given of a situation in which the B light 4 enters the R fluorescent reflector 7R of the color wheel 7. For the B light 4, R light excited by the R fluorescent reflector 7R is diffused and reflected. Of reflected R light 10R, light in substantially the lower-half section below the optical axis 8 in FIG. 1 is refracted through the lenses 6 and 5 to be substantially collimated. The light transmits through the dichroic mirror 3 and enters the integrator 13 via the lenses 11 and 12. Of the reflected R light 10R, light in substantially the upper-half section above the optical axis 8 in FIG. 1 is refracted by the lenses 6 and 5 to be substantially collimated. The light passes other than the section of the color wheel 7 in which the dichroic mirror 3 is disposed, and enters the integrator 13 via the lenses 11 and 12.

As above, the reflected B light 10B, the reflected G light 10G and the reflected R light 10R proceed together to the integrator 13.

The integrator 13 produces light 14 having uniform luminescence distribution. The light 14 passes a lens 15, a lens 16, a mirror 17, and a lens 18 to enter a Digital Micromirror Device (DMD) 19. Light 20 reflected by the DMD 19 enters a projection lens unit 21 via a lens 18. Light 22 emitted from the projection lens unit 21 is projected as an image onto a screen, not shown.

The DMD 19 is an image display device developed by Texas Instruments Inc.

According to the first embodiment, it is possible to reflect both of the G light 10G and the B light 10B by the color wheel 7. Hence, it is advantageously possible to provide a light source device and an image display apparatus in which by removing the blue-light detour path required in the prior art, the size and the number of parts thereof are reduced.

Further, according to the first embodiment, it is possible to reflect all of the B light 10B, the G light 10G and the R light 10R by the color wheel 7. Hence, it is possible to remove the blue-light detour path required in the prior art and it is not required to additionally use the R light source. As a result, it is advantageously possible to provide a light source device and an image display apparatus in which the size and the number of parts thereof are reduced.

In the first embodiment, the dichroic mirror 3 has a spectral transmissive reflectivity characteristic to reflect B light and to transmit G light and R light. However, the present invention is not restricted by this embodiment. The gist of the present invention resides in that the B light 10B is mirror-reflected in the mirror reflection by the color wheel 7. Various modifications and variations are possible within the scope of the present invention.

### Second Embodiment

Next, description will be given of the second embodiment of the present invention.

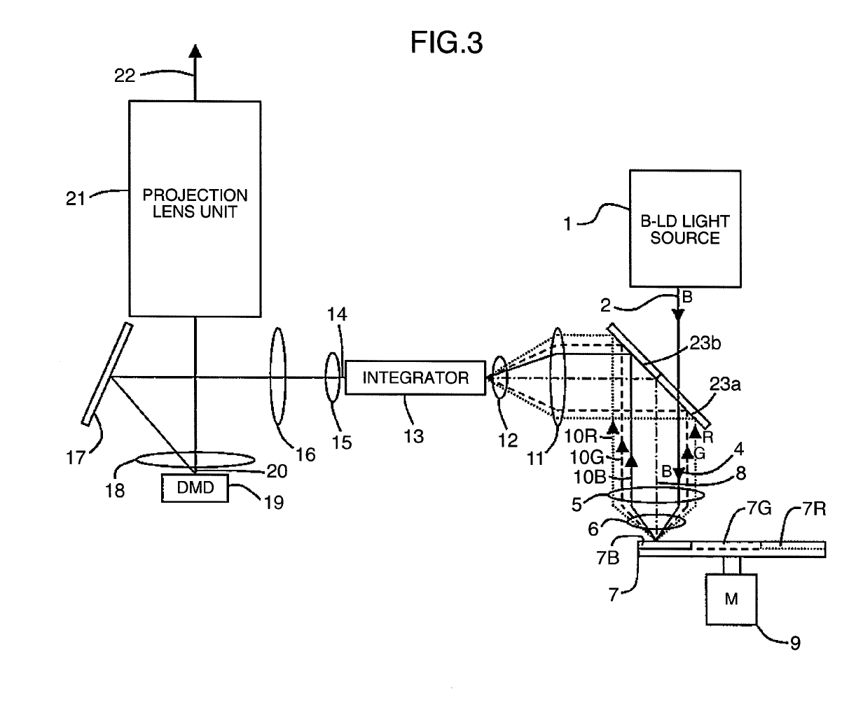

FIG. 3 is a top view showing main sections of a light source device and an image display apparatus in the second embodiment. In FIG. 3, the same reference numerals as those of FIGS. 1 and 2 represent the same constituent components.

Substantially collimated B light 2 from the B-LD light source 1 enters a dichroic mirror 23a. The dichroic mirror 23a has a spectral transmissive reflectivity characteristic to transmit B light and to reflect G light and R light.

B light 4 transmitted through the dichroic mirror 23a is refracted by the lenses 5 and 6 to be focused substantially onto one point and then enters the color wheel 7.

The lenses 5 and 6 have a shared optical axis 8, and the B light 4 transmits through substantially the right-half section with respect to the optical axis 8 in FIG. 1. That is, the dichroic mirror 23a is disposed in substantially the right-half section with respect to the optical axis 8 in FIG. 1.

In the configuration of the second embodiment, the B light 4 transmits through substantially the right-half section with respect to the optical axis 8 in FIG. 1. However, the present invention is not restricted by this embodiment. The gist of the present invention resides in that the center of the light flux of the B light 4 transmitted through the dichroic mirror 23a is on other than the optical axis 8 of the lenses 5 and 6. Various modifications and variations are possible within the scope of the present invention.

The color wheel 7 is almost the same as that shown in FIG. 2 and circumferentially includes a B light mirror reflector 7B, a G fluorescent reflector 7G, and an R fluorescent reflector 7R. By rotating the color wheel 7 by a motor 9, the reflector to receive the B light 4 is changed in a time-division manner. FIG. 2 shows a state in which the B light 4 just enters the B light mirror reflector 7B.

FIG. 3 also shows a state in which the B light 4 just enters the B light mirror reflector 7B. The B light 4 is mirror-reflected by the B light mirror reflector 7B. Reflected B light 10B propagates through substantially the right-half section with respect to the optical axis 8 in FIG. 1 and is refracted through the lenses 6 and 5 to be again substantially collimated. The light is then fed as incident light onto a reflection mirror 23b.

The reflection mirror 23b is disposed adjacent to the dichroic mirror 3.

The B light 10B incident onto the reflection mirror 23b is reflected by the reflection mirror 23b to enter an integrator 13 via a lens 11 and a lens 12.

Next, description will be given of a situation in which the B light 4 enters the G fluorescent reflector 7G of the color wheel 7. For the B light 4, G light excited by the G fluorescent reflector 7G is diffused and reflected. Of reflected G light 10G, light in substantially the right-half section with respect to the optical axis 8 in FIG. 1 is refracted through the lenses 6 and 5 to be substantially collimated. The light is reflected by the dichroic mirror 23a and enters the integrator 13 via the lenses 11 and 12. Of the reflected G light 10G light in substantially the left-half section with respect to the optical axis 8 in FIG. 1 is refracted by the lenses 6 and 5 to be substantially collimated. The light is reflected by the reflection mirror 23b and enters the integrator 13 via the lenses 11 and 12.

Description will now be given of a situation in which the B light 4 enters the R fluorescent reflector 7R of the color wheel 7. For the B light 4, R light excited by the R fluorescent reflector 7R is diffused and reflected. Of reflected R light 10R, light in substantially the right-half section with respect to the optical axis 8 in FIG. 1 is refracted through the lenses 6 and 5 to be substantially collimated. The light is reflected by the dichroic mirror 23a and enters the integrator 13 via the lenses 11 and 12. Of the reflected R light 10R, light in substantially the left-half section with respect to the optical axis 8 in FIG. 1 is refracted by the lenses 6 and 5 to be substantially collimated. The light is reflected by the reflection mirror 23b and enters the integrator 13 via the lenses 11 and 12.

As above, the reflected B light 10B, the reflected G light 10G and the reflected R light 10R proceed together to the integrator 13.

The integrator 13 produces light 14 having uniform luminescence distribution. The light 14 passes a lens 15, a lens 16, a mirror 17, and a lens 18 to enter a Digital Micromirror Device (DMD) 19. Light 20 reflected by the DMD 19 enters a projection lens unit 21 via a lens 18. Light 22 emitted from the projection lens unit 21 is projected as an image onto a screen, not shown.

According to the second embodiment, it is possible as in the first embodiment to reflect both of the G light 10G and the B light 10B by the color wheel 7. Hence, it is advantageously possible to provide a light source device and an image display apparatus in which by removing the blue-light detour path required in the prior art, the size and the number of parts thereof are reduced.

Further, according to the second embodiment, it is possible as in the first embodiment to reflect all of the B light 10B, the G light 10G and the R light 10R by the color wheel 7. Hence, it is possible to remove the blue-light detour path required in the prior art and it is not required to additionally use the R light source. As a result, it is advantageously possible to provide a light source device and an image display apparatus in which the size and the number of parts thereof are reduced.

In comparison with the first embodiment, the second embodiment additionally includes the reflection mirror 23b. That is, one part is additionally employed in the second embodiment. The first embodiment is hence superior to the second embodiment in the number of parts.

On the other hand, in the vicinity of the optical axis of the dichroic mirror 3 of the first embodiment, mechanical vignetting takes place due to thickness of the mirror 3. It is hence required to reduce the thickness of the mirror 3, to thereby minimize reduction in the light utilization efficiency. In the second embodiment, it is possible to install the reflection mirror 23b and the dichroic mirror 23a adjacent to each other. It is hence possible to connect reflection surfaces of the mirrors 23b and 23a to each other in the vicinity of the optical axis 8. As a result, without reducing the mirror thickness, it is possible to efficiently reflect the G light 10G and the R light 10R even in the vicinity of the optical axis 8. Hence, the second embodiment is superior to the first embodiment in the light utilization efficiency in the vicinity of the optical axis 8.

In the first and second embodiments, the color wheel includes a B light mirror reflector 7B, a G fluorescent reflector 7G, and an R fluorescent reflector 7R. However, the present invention is not restricted by this embodiment. The gist of the present invention resides in that the B light 10B is mirror-reflected by the color wheel 7. Hence, it is possible to implement an embodiment without using the R luminescent substance.

### Third Embodiment

Next, description will be given of the third embodiment of the present invention.

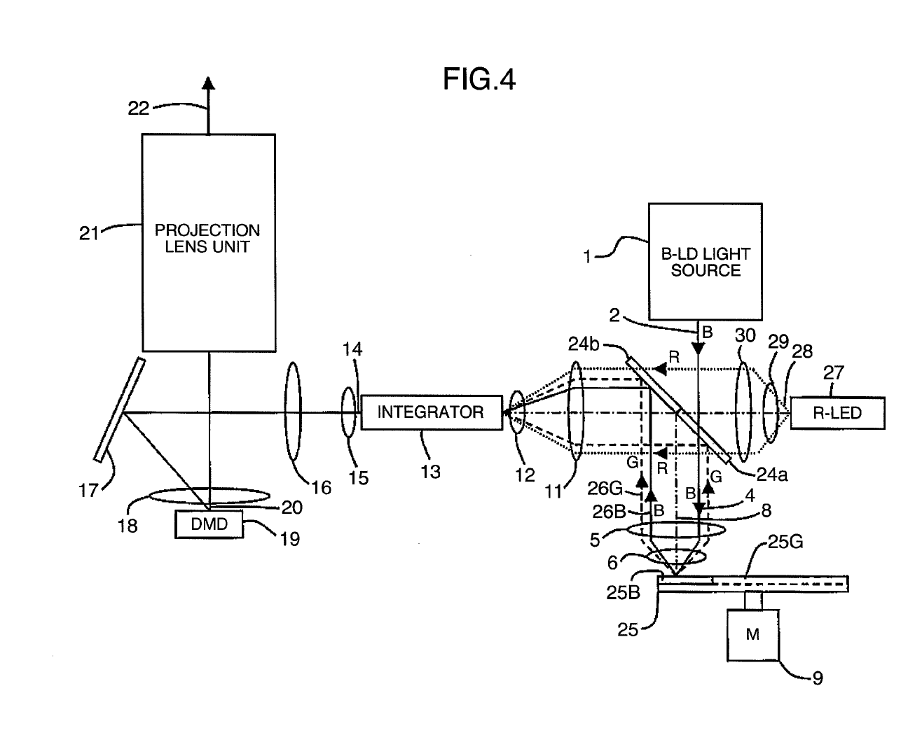

FIG. 4 is a top view showing main sections of a light source device and an image display apparatus in the third embodiment.

Substantially collimated B light 2 from the B-LD light source 1 enters a dichroic mirror 24a. The dichroic mirror 24a has a spectral transmissive reflectivity characteristic to transmit B light, to reflect G light, and to transmit R light.

B light 4 transmitted through the dichroic mirror 24a is refracted by the lenses 5 6 to be focused substantially onto one point and then enters the color wheel 25.

The lenses 5 and 6 have a shared optical axis 8, and the B light 4 transmits through substantially the right-half section with respect to the optical axis 8 in FIG. 4. That is, the dichroic mirror 24a is disposed in substantially the right-half section with respect to the optical axis 8 in FIG. 4.

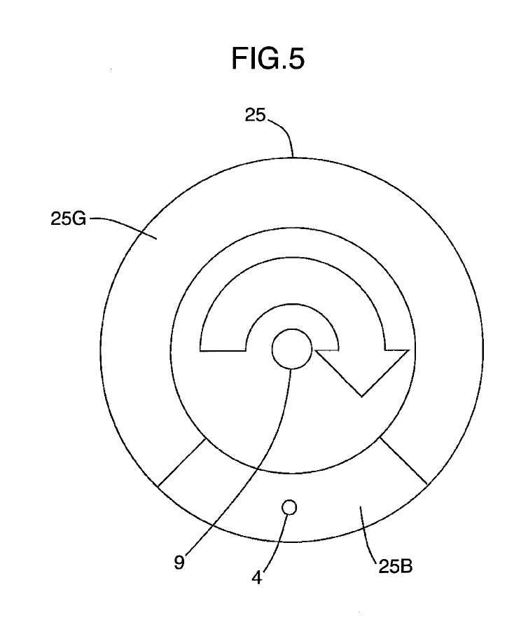

FIG. 5 is a top view of the color wheel 25 of the third embodiment.

The color wheel 25 circumferentially includes a B light mirror reflector 25B and a G fluorescent reflector 25G. By rotating the color wheel 25 by a motor 9, the reflector to receive the B light 4 is changed in a time-division manner. FIG. 5 shows a state in which the B light 4 is just incident onto the B light mirror reflector 25B.

FIG. 4 also shows a state in which the B light 4 just enters the B light mirror reflector 25B of the color wheel 25. The B light 4 is mirror-reflected by the B light mirror reflector 25B. Reflected B light 26B propagates through substantially the left-half section with respect to the optical axis 8 in FIG. 4 and is refracted through the lenses 6 and 5 to be again substantially collimated. The light is then fed as incident light onto a dichroic mirror 24b. The dichroic mirror 24b has a spectral transmissive reflectivity characteristic to reflect B light and G light and to transmit R light.

The dichroic mirror 24b is disposed adjacent to the dichroic mirror 24a.

The B light 26B incident onto the dichroic mirror 24b is reflected by the dichroic mirror 24b to enter the integrator 13 via the lenses 11 and 12.

Next, description will be given of a situation in which the B light 4 enters the G fluorescent reflector 25G of the color wheel 25. For the B light 4, G light excited by the G fluorescent reflector 25G is diffused and reflected. Of reflected G light 25G light in substantially the right-half section with respect to the optical axis 8 in FIG. 4 is refracted through the lenses 6 and 5 to be substantially collimated. The light is reflected by the dichroic mirror 24a and then enters the integrator 13 via the lenses 11 and 12. Of the reflected G light 25G, light in substantially the left-half section with respect to the optical axis 8 in FIG. 4 is refracted by the lenses 6 and 5 to be substantially collimated. The light is reflected by the dichroic mirror 24b and enters the integrator 13 via the lenses 11 and 12.

Next, description will be given of R light in the system. The R light is produced by use of a Red Light-Emission Diode (R-LED) 27.

The R light 28 is diffused and emitted by the R-LED 27. Of the R light 28, light in substantially the lower-half section below the optical axis 8 in FIG. 4 is refracted through a lens 29 and a lens 30 to be substantially collimated. The light transmits through the dichroic mirror 24a and enters the integrator 13 via the lenses 11 and 12. Of the R light 28, light in substantially the upper-half section above the optical axis 8 in FIG. 4 is refracted by the lenses 29 and 30 to be substantially collimated. The light transmits through the dichroic mirror 24b and enters the integrator 13 via the lenses 11 and 12.

As above, the reflected B light 26B, the reflected G light 26G and the R light 28 proceed together to the integrator 13.

The integrator 13 produces light 14 having uniform luminescence distribution. The light 14 passes the lenses 15 and 16, the mirror 17, and the lens 18 to enter the DMD 19. Light 20 reflected by the DMD 19 enters the projection lens unit 21 via the lens 18. Light 22 emitted from the projection lens unit 21 is projected as an image onto a screen, not shown.

According to the third embodiment, it is possible as in the first and second embodiments to reflect both of the G light 25G and the B light 25B by the color wheel 25. Hence, it is advantageously possible to provide a light source device and an image display apparatus in which by removing the blue-light detour path required in the prior art, the size and the number of parts thereof are reduced.

Further, according to the third embodiment, the R-LED 27 is additionally disposed for the R light 28. However, since the color mixing is conducted by use of the dichroic mirrors 24a and 24b which are beforehand arranged, it is not required to additionally install any dichroic mirror for the mixing of the R light 28. Hence, it is possible to remove the red-light confluent path required in the prior art. As a result, even when the R-LED 27 is employed, it is advantageously possible to provide a light source device and an image display apparatus in which the size and the number of parts thereof are reduced.

In the third embodiment, the R-LED 27 is employed for the R light. However, the present invention is not restricted by this embodiment. The system may be configured by disposing a Red Laser Diode (R-LD) light source 32 in place of the R-LED 27.

### Fourth Embodiment

Next, description will be given of the fourth embodiment of the present invention.

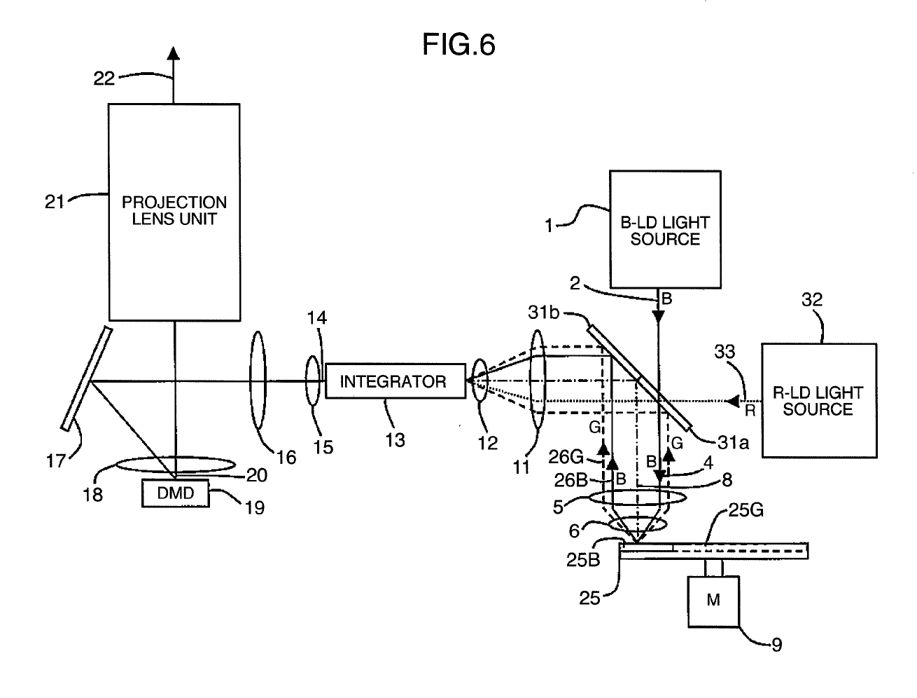

FIG. 6 shows, in a top view, main sections of a light source device and an image display apparatus in the fourth embodiment.

Substantially collimated B light 2 from the B-LD light source 1 enters a dichroic mirror 31a. The dichroic mirror 31a has a spectral transmissive reflectivity characteristic to transmit B light, to reflect G light, and to transmit R light.

B light 4 transmitted through the dichroic mirror 31a is refracted by the lenses 5 and 6 to be focused substantially onto one point and then enters the color wheel 25.

The lenses 5 and 6 have a shared optical axis 8, and the B light 4 transmits through substantially the right-half section with respect to the optical axis 8 in FIG. 6. That is, the dichroic mirror 31a is disposed in substantially the right-half section with respect to the optical axis 8 in FIG. 6.

The color wheel 25 is almost the same as that of the third embodiment shown in FIG. 5 and circumferentially includes a B light mirror reflector 25B and a G fluorescent reflector 25G. By rotating the color wheel 25 by a motor 9, the reflector to receive the B light 4 is changed in a time-division manner. FIG. 5 shows a state in which the B light 4 just enters the B light mirror reflector 25B.

FIG. 6 also shows a state in which the B light 4 is just incident onto the B light mirror reflector 25B of the color wheel 25. The B light 4 is mirror-reflected by the B light mirror reflector 25B. Reflected B light 26B propagates through substantially the left-half section with respect to the optical axis 8 in FIG. 6 and is refracted through the lenses 6 and 5 to be again substantially collimated. The light is then fed as incident light onto the dichroic mirror 31b.

The dichroic mirror 31b is disposed adjacent to the dichroic mirror 31a.

The B light 26B incident onto the reflection mirror 31b is reflected by the reflection mirror 31b to enter the integrator 13 via the lenses 11 and 12.

Next, description will be given of a situation in which the B light 4 enters the G fluorescent reflector 25G of the color wheel 25. For the B light 4, G light excited by the G fluorescent reflector 25G is diffused and reflected. Of reflected G light 25G, light in substantially the right-half section with respect to the optical axis 8 in FIG. 6 is refracted through the lenses 6 and 5 to be substantially collimated. The light is reflected by the dichroic mirror 31a and enters the integrator 13 via the lenses 11 and 12. Of the reflected G light 25G light in substantially the left-half section with respect to the optical axis 8 in FIG. 6 is refracted by the lenses 6 and 5 to be substantially collimated. The light is reflected by the reflection mirror 31b and then enters the integrator 13 via the lenses 11 and 12.

Description will now be given of R light in the system. The R light is produced by use of an R-LD light source 32. The R-LD light source 32 includes a plurality of R-LD, not shown.

R light 33 emitted from the R-LD light source 32 transmits through the dichroic mirror 31a and enters the integrator 13 via the lenses 11 and 12.

As above, the reflected B light 26B, the reflected G light 26G and the R light 33 proceed together to the integrator 13.

The integrator 13 produces light 14 having uniform luminescence distribution. The light 14 passes the lenses 15 and 16, the mirror 17, and the lens 18 to enter the DMD 19. Light 20 reflected by the DMD 19 enters the projection lens unit 21 via the lens 18. Light 22 emitted from the projection lens unit 21 is projected as an image onto a screen, not shown.

According to the fourth embodiment, it is possible as in the third embodiment to reflect both of the G light 25G and the B light 25B by the color wheel 25. Hence, it is advantageously possible to provide a light source device and an image display apparatus in which by removing the blue-light detour path required in the prior art, the size and the number of parts thereof are reduced.

Further, according to the fourth embodiment, the R-LD 32 is additionally disposed for the R light 33. However, since the color mixing is conducted by use of the dichroic mirrors 31a and the reflection mirror 31b which are beforehand arranged, it is not required to additionally install any dichroic mirror for the mixing of the R light 33. Hence, it is possible to remove the red-light confluent path required in the prior art. As a result, even when the R-LD 33 is employed, it is advantageously possible to provide a light source device and an image display apparatus in which the size and the number of parts thereof are reduced.

Also, it is possible to employ the reflection mirror 31b in place of the dichroic mirror 24b used in the third embodiment. This leads to an advantage that the reflection mirror 31b is more simple in multiplayer structure than the dichroic mirror 24b and is produced at a low cost.

In the fourth embodiment, the R light from the R-LD light source 32 is guided to the dichroic mirror 31a. However, the present invention is not restricted by this embodiment. The system may be configured such that the R light 33 is incident to other than the dichroic mirror 31a.

### Fifth Embodiment

Next, description will be given of the fifth embodiment of the present invention.

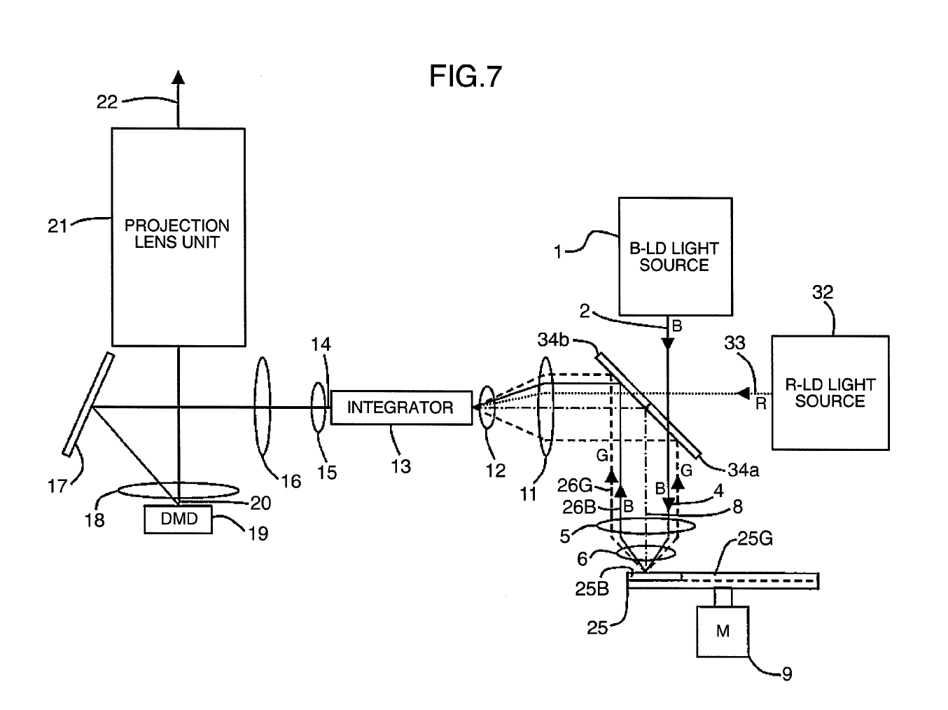

FIG. 7 is a top view showing main sections of a light source device and an image display apparatus in the fifth embodiment.

Substantially collimated B light 2 from the B-LD light source 1 enters a dichroic mirror 34a. The dichroic mirror 34a has a spectral transmissive reflectivity characteristic to transmit B light and to reflect G light.

B light 4 transmitted through the dichroic mirror 34a is refracted by the lenses 5 and 6 to be focused substantially onto one point and then enters the color wheel 25.

The lenses 5 and 6 have a shared optical axis 8, and the B light 4 transmits through substantially the right-half section with respect to the optical axis 8 in FIG. 7. That is, the dichroic mirror 34a is disposed in substantially the right-half section with respect to the optical axis 8 in FIG. 7.

The color wheel 25 is almost the same as that of the third and fourth embodiments shown in FIG. 5 and circumferentially includes a B light mirror reflector 25B and a G fluorescent reflector 25G. By rotating the color wheel 25 by a motor 9, the reflector to receive the B light 4 is changed in a time-division manner. FIG. 5 shows a state in which the B light 4 just enters the B light mirror reflector 25B.

FIG. 7 also shows a state in which the B light 4 just enters the B light mirror reflector 25B of the color wheel 25. The B light 4 is mirror-reflected by the B light mirror reflector 25B. Reflected B light 26B propagates through substantially the left-half section with respect to the optical axis 8 in FIG. 7 and is refracted through the lenses 6 and 5 to be again substantially collimated. The light is then fed as incident light onto the dichroic mirror 34b. The dichroic mirror 34b has a spectral characteristic to reflect B light and G light and to transmit R light.

The dichroic mirror 34b is disposed adjacent to the dichroic mirror 34a.

The B light 26B incident onto the dichroic mirror 34b is reflected by the dichroic mirror 34b to enter the integrator 13 via the lenses 11 and 12.

Next, description will be given of a situation in which the B light 4 enters the G fluorescent reflector 25G of the color wheel 25. For the B light 4, G light excited by the G fluorescent reflector 25G is diffused and reflected. Of reflected G light 25Q light in substantially the right-half section with respect to the optical axis 8 in FIG. 7 is refracted through the lenses 6 and 5 to be substantially collimated. The light is reflected by the dichroic mirror 34a and then enters the integrator 13 via the lenses 11 and 12. Of the reflected G light 25Q light in substantially the left-half section with respect to the optical axis 8 in FIG. 7 is refracted by the lenses 6 and 5 to be substantially collimated. The light is reflected by the reflection mirror 34b and enters the integrator 13 via the lenses 11 and 12.

Description will now be given of R light in the system. The R light is produced by use of an R-LD light source 32. The R-LD light source 32 includes a plurality of R-LD, not shown.

R light 33 emitted from the R-LD light source 32 transmits through the dichroic mirror 34b and enters the integrator 13 via the lenses 11 and 12.

As above, the reflected B light 26B, the reflected G light 26Q and the R light 33 proceed together to the integrator 13.

The integrator 13 produces light 14 having uniform luminescence distribution. The light 14 passes the lenses 15 and 16, the mirror 17, and the lens 18 to enter the DMD 19. Light 20 reflected by the DMD 19 enters the projection lens unit 21 via the lens 18. Light 22 emitted from the projection lens unit 21 is projected as an image onto a screen, not shown.

According to the fifth embodiment, it is possible as in the third and fourth embodiments to reflect both of the G light 25G and the B light 25B by the color wheel 25. Hence, it is advantageously possible to provide a light source device and an image display apparatus in which by removing the blue-light detour path required in the prior art, the size and the number of parts thereof are reduced.

Further, according to the fifth embodiment, the R-LD light source 32 is additionally disposed for the R light 33 as in the fourth embodiment. However, since the color mixing is conducted by use of the dichroic mirror 34b beforehand arranged, it is not required to additionally install any dichroic mirror for the mixing of the R light 33. Hence, it is possible to remove the red-light confluent path required in the prior art. As a result, even when the R-LD light source 33 is employed, it is advantageously possible to provide a light source device and an image display apparatus in which the size and the number of parts thereof are reduced.

The fifth embodiment includes the dichroic mirror 34b in place of the dichroic mirror 31a of the fourth embodiment. While the dichroic mirror 31a has a band-pass filter characteristic, the dichroic mirror 34b has other than the band-pass filter characteristic. Hence, the dichroic mirror 34b is more simple in multiplayer structure than the dichroic mirror 31a and is produced at a low cost.

As described above, according to the first to fifth embodiments, it is possible to reflect both of the green light and the blue light by the color wheel. Hence, it is advantageously possible to provide a light source device and an image display apparatus in which by removing the blue-light detour path, the size and the number of parts thereof are reduced.

It should be further understood by those skilled in the art that although the foregoing description has been made on embodiments of the invention, the invention is not limited thereto and various changes and modifications may be made without departing from the spirit of the invention and the scope of the appended claims.

1. A light source device and an image display apparatus, comprising:
a Blue Laser Diode (B-LD) light source unit;
a dichroic mirror to reflect substantially collimated Blue (B) light from the B-LD light source unit;
a lens to focus the B light reflected by the dichroic minor; and
a color wheel comprising a Green (G) fluorescent section which is excited by the collimated B light to emit and to reflect G light and a B mirror reflector to mirror-reflect the B light, wherein a center of a light flux of the B light reflected by the dichroic mirror is on other than an optical axis of the lens.

2. A light source device and an image display apparatus according to claim 1, wherein the B light reflected by the dichroic mirror passes through substantially a half-section with respect to the optical axis of the lens.

3. A light source device and an image display apparatus, comprising:
a Blue Laser Diode (B-LD) light source unit;
a dichroic mirror to transmit substantially collimated Blue (B) light from the B-LD light source unit;
a lens to focus the B light transmitted by the dichroic minor; and
a color wheel comprising a Green (G) fluorescent section which is excited by the collimated B light to emit and to reflect G light and a B mirror reflector to minor-reflect the B light, wherein
a center of a light flux of the B light transmitted by the dichroic mirror is on other than an optical axis of the lens.

4. A light source device and an image display apparatus according to claim 3, wherein the B light transmitted by the dichroic mirror passes through substantially a half-section with respect to the optical axis of the lens.
